(19) United States
(12) Patent Application Publication
(10) Pub. No.: US 2014/0002004 A1
(43) Pub. Date: Jan. 2, 2014

(54) PORTABLE CHARGING STATION

(71) Applicant: Aviiq IP Inc, Hong Kong (CN)

(72) Inventors: Cezanne-Simon Farris-Gilbert, Long Beach, CA (US); Alan Chun-Ye Yeung, Santa Ana, CA (US)

(21) Appl. No.: 13/929,503

(22) Filed: Jun. 27, 2013

Related U.S. Application Data
(60) Provisional application No. 61/666,616, filed on Jun. 29, 2012.

(51) Int. Cl. H02J 7/00

(52) U.S. Cl. CPC H02J 7/0027
USPC 320/103; 320/114

(57) ABSTRACT

A portable charging station is provided for selectively charging a plurality of personal electronic devices. The portable charging station includes a wall charger, a hub separate from the wall charger and having a plurality of USB ports to selectively charge one or more of the plurality of personal electronic devices and a case movable between a transport configuration in which the case encloses the wall charger and the hub and a charging configuration in which the case reveals the wall charger and the hub. The portable charging station may further include a battery and the hub may include a switch for switching between a battery charging mode and an outlet charging mode. Related methods of charging personal electronic devices are also provided.

### BACKGROUND

1. Technical Field

The present disclosure is related to systems for charging personal electronic devices, such as, for example, smart phones, tablet computers and the like.

2. Description of the Related Art

It is now common for individuals to possess and use multiple personal electronic devices, such as, for example, smart phones, tablet computers and the like. These devices are typically quite portable, and as such, are often required to be charged on the go at various places. Accordingly, various charging devices have been developed to facilitate charging on the go. These charging devices, however, are often specifically designed for a single type of device and do not adequately facilitate charging of multiple personal electronic devices. For example, personal electronic devices generally come with individual portable chargers specific to the device, thus requiring an owner to carry multiple chargers to account for each of his or her personal electronic devices. Carrying these chargers and managing the respective cables thereof can be quite inconvenient and cumbersome.

Accordingly, it is believed that portable charging systems which can conveniently and efficiently charge multiple personal electronic devices in a compact and portable form factor are desirable.

### BRIEF SUMMARY

The portable charging station devices and related methods described herein provide for charging multiple personal electronic devices in a particularly compact and portable form factor. The devices are particularly well suited for travelers where portability, compact form and ease of use are especially beneficial.

According to one embodiment, a portable charging station to selectively charge a plurality of personal electronic devices may be summarized as including a wall charger, a hub separate from the wall charger and having a plurality of USB ports to selectively charge one or more of the plurality of personal electronic devices during a charging operation, and a case to receive the same. The case may be movable between a transport configuration in which the case encloses the wall charger and the hub and a charging configuration in which the case reveals the wall charger and the hub. The case may include a hub securing device to secure the hub to the case at least when the case is in the transport configuration and a wall charger securing device to secure the wall charger to the case at least when the case is in the transport configuration.

The case may further include a plurality of distinct receptacles, each configured to receive a portion of a respective electrical conductor emanating from a respective one of the plurality of USB ports when charging the plurality of personal electronic devices. The case may include opposing sides and the hub securing device and the plurality of distinct receptacles may be positioned on a same one of the opposing sides such that the plurality of USB ports are directed toward the plurality of distinct receptacles when the hub is secured to the case. Each of the plurality of distinct receptacles may be configured to receive the respective electrical conductor emanating from the respective one of the plurality of USB ports through a conductor inlet and to store a portion of the electrical conductor therein. Each of the plurality of distinct receptacles may be further configured such that each respective electrical conductor exits the receptacle via a conductor outlet distinct from the conductor inlet.

The hub securing device may be a pocket formed on an interior surface of the case and the hub may include an extension to slidably engage the pocket. The wall charger securing device may include an elastic loop coupled to an interior surface of the case to closely receive the wall charger when received therein. In other instances, the wall charger securing device may include straps with hook and loop fastening devices to selectively secure the wall charger to the case. The wall charger securing device and the hub securing device may be located on the same side of the case. The case may further include at least one storage pocket on a side of the case opposite the side on which the wall charger securing device and the hub securing device are located.

The wall charger may include an electrical conductor to selectively attach to the hub and a peripheral recess to receive the electrical conductor when the wall charger is stored within the case. The hub may include a built-in retractable USB cable in electrical communication with a USB data port to enable syncing and charging of a personal electronic device connected to the USB data port from an auxiliary computing device when the built-in retractable USB cable is attached to the auxiliary computing device. The charging station may further include a set of cable management devices coupleable to the case, each cable management device configured to receive and store a portion of a respective conductor emanating from a respective one of plurality of USB ports in a bundled manner and readily separable from the case with the respective conductor to alternatively store the portion of the respective conductor apart from the case.

The portable charging station may further comprise a battery, such as, for example, an integrated lithium polymer rechargeable battery pack, that is electrically coupled to the hub to selectively supply power to the hub for charging the plurality of personal electronic devices, and the hub may include a switch for switching between different device charging modes. In one charging mode, the devices receive power from the hub via the wall charger. In another charging mode, the devices receive power from the hub via the battery. In this manner, a user can conveniently switch between a battery charging mode for charging devices with the battery and an outlet charging mode for charging devices via the wall charger coupled to an electrical outlet. The wall charger also supplies power to the battery to recharge the battery as needed.

According to another embodiment, a method of charging personal electronic devices may be summarized as including: transporting a wall charger and a USB hub within a case; removing the wall charger from the case; electrically coupling the wall charger to a power source and the hub with the hub secured to an interior surface of the case; and coupling one or more of the personal electronic devices to a respective USB port of the hub to charge each personal electronic device.

The method may further include switching between a first power mode in which the personal electronic devices are charged via the wall charger through the intermediary of the hub and a second power mode in which the personal electronic devices are charged via a battery received in the case through the intermediary of the hub.

The method may further include storing a portion of at least one electrical conductor of the personal electronic devices in a distinct receptacle of the case which is positioned adjacent to the USB hub. The method may further include routing the at least one electrical conductor through the receptacle via a conductor inlet and a conductor outlet of the receptacle; and bundling a substantial portion of the conductor within the receptacle. The method may further include resting at least one personal electronic device on an interior surface of the case opposite a side of the case in which the hub is secured while charging the personal electronic device. The method may further include storing an electrical conductor which is configured to selectively attach to the USB hub within a peripheral recess of the wall charger when the wall charger is stored within the case. The method may further include syncing a personal electronic device to an auxiliary computing device via a USB data port of the USB hub and a built-in retractable USB cable of the USB hub. The method may further include simultaneously charging at least three personal electronic devices via the USB hub with the case splayed open about a spine thereof. The method may include bundling a portion of at least one electrical conductor of the personal electronic devices about a cable management device that is removably coupleable to the case.

### BRIEF DESCRIPTION OF THE SEVERAL VIEWS OF THE DRAWINGS

FIG. 1 is an isometric view of a portable charging station, according to one embodiment, which is shown in a charging configuration.

FIG. 2 is a top plan view of the portable charging station of FIG. 1 in a storage configuration with a case thereof open.

FIG. 3 is a side elevational view of the portable charging station of FIG. 1 in a storage configuration with the case thereof open.

FIG. 4 is a front elevational view of the portable charging station of FIG. 1 in a storage configuration with the case thereof open.

FIG. 5 is an isometric view of the portable charging station of FIG. 1 in a storage configuration with the case thereof closed.

FIG. 6 is an isometric view of a portable charging station, according to another embodiment, which is shown in a charging configuration.

FIG. 7 is a top plan view of a portable charging station, according to another embodiment, in a storage configuration with a case thereof open.

FIG. 8 is a side elevational view of the portable charging station of FIG. 7 in a storage configuration with the case thereof open.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures, devices, systems and methods associated with charging personal electrical devices may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

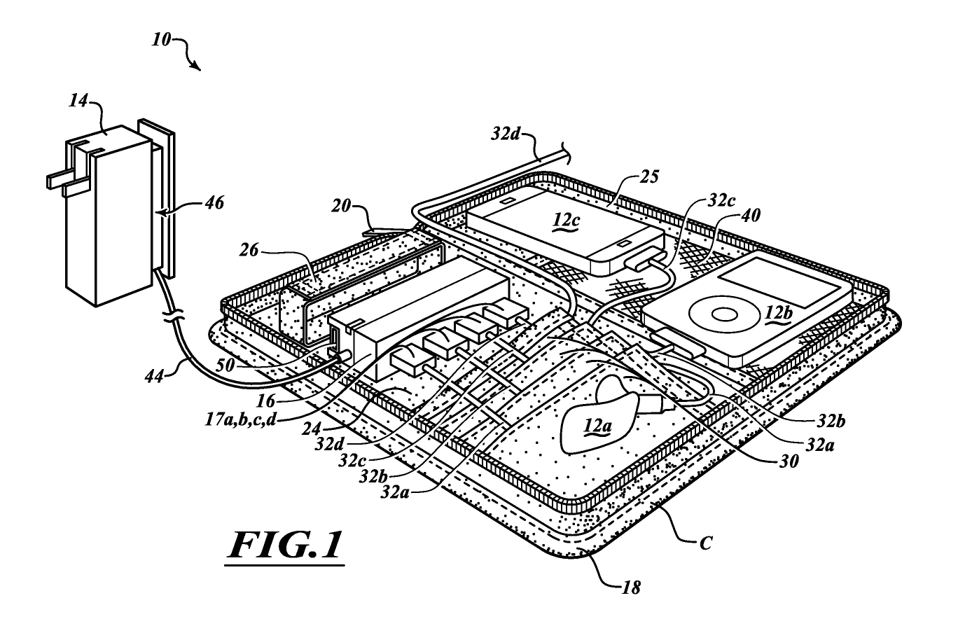

FIGS. 1 through 5 show a portable charging station 10, according to one example embodiment, for selectively charging a plurality of personal electronic devices 12a, 12b, 12c (collectively “12”), such as, for example, a blue tooth earpiece device 12a, a digital music player 12b and a smart phone 12c. The portable charging station 10 includes a wall charger 14, a charging hub 16 and a case 18. The hub 16 is separate from the wall charger 14 and includes a plurality of USB ports 17a, 17b, 17c, 17d (collectively “17”) to selectively charge one or more of the plurality of personal electronic devices 12 during a charging operation in which the wall charger 14 is removed from the case 18 and plugged into a socket (not shown), such as, for example, a household socket connected to mains power. The USB ports may include three active ports 17a, 17b, 17c for direct charging and one data port or pass through port for syncing and charging of a personal electronic device 12 via an alternate power source, such as, for example, a separate laptop or desktop computer with its own internal power source. For this purpose, a coupling cable 50 with USB or other connector to power sync the device 12 may be provided. The coupling cable 50 may be auto-retractable within the hub 16 to retract into a stored configuration when not in use, as shown, for example, in FIGS. 1 through 4.

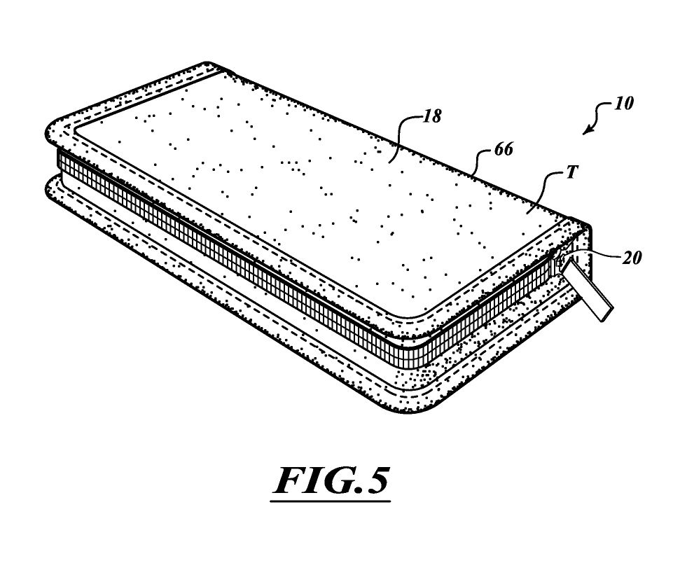

The case 18 may be a portfolio that is movable between a transport configuration T (FIG. 5) in which the case 18 encloses the wall charger 14 and the hub 16 and a charging configuration C (FIGS. 1 through 4) in which the case 18 reveals the wall charger 14 and the hub 16. In some embodiments, the case 18 may include a closure device, such as, for example, a zipper mechanism 20, flaps with hook and loop fasteners, etc., to secure the case 18 in the transport configuration T. The case 18 may be rigid, semi-rigid or flexible or combinations thereof and may comprise various materials, such as, for example, nylon or other synthetic or natural materials. The case 18 may take on a variety of forms, including, for example, a sleeve, a tote, a notebook, a portfolio, a briefcase or other receptacle of sufficient size to accommodate the wall charger 14 and the hub 16.

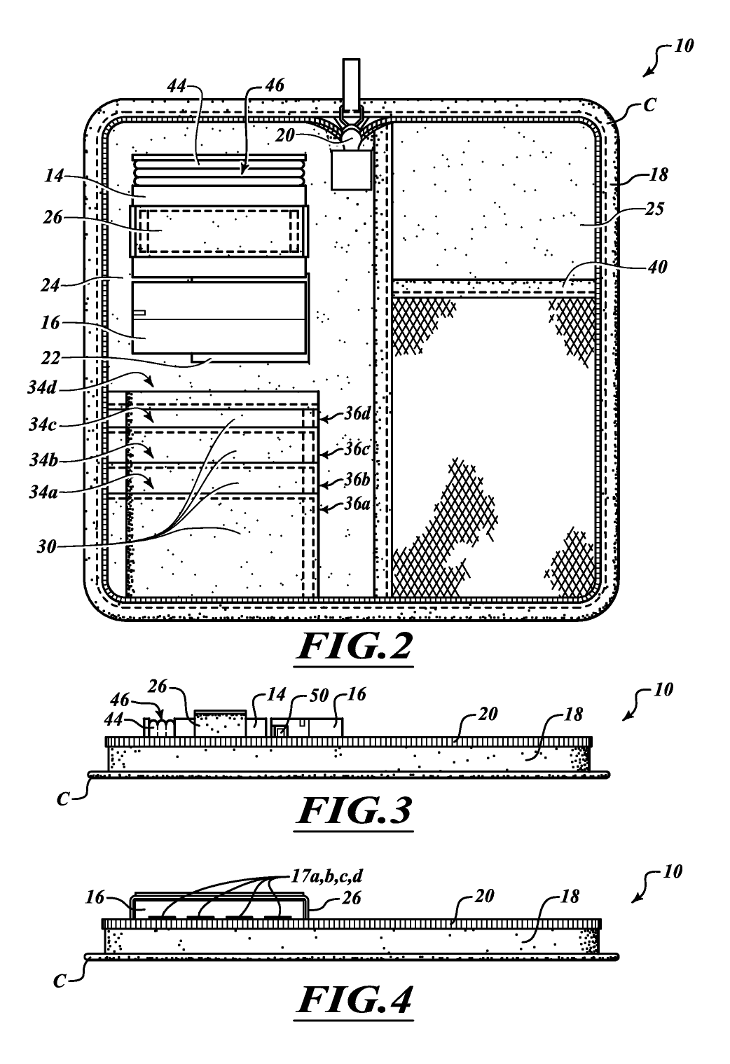

While in the transport configuration T, the wall charger 14 and the hub 16 are preferably removably coupled to the interior of the case 18. For this purpose, the case 18 may include a hub securing device 22 (FIG. 2) to temporarily secure the hub 16 to the case 18. For instance, in some embodiments, the hub securing device 22 may be a pocket formed on an interior surface 24 of the case 18 and the hub 16 may include an extension (not visible), such as a clip, to slidably engage the pocket. In this manner, the hub 16 can be readily removed from and attached to the case 18 to facilitate charging activities.

The case 18 may further include a wall charger securing device 26 (FIG. 2) to secure the wall charger 14 to the case 18 at least when the case is in the transport configuration T. For instance, in some embodiments, the case 18 may include a wall charger securing device 26 in the form of an elastic loop coupled to the interior surface 24 of the case 18 to closely receive the wall charger 14 when stored therein. In other instances, the wall charger securing device 26 may include straps with hook and loop fasteners to selectively secure the wall charger 14 to the case 18. The hub securing device 22 and the wall charger securing device 26 may be formed in or otherwise provided on the same interior surface 24 of the case 18 and in close proximity to each other such that the hub 16 and wall charger 14 may be securely stowed in relatively close proximity to each other, as shown, for example, in FIG. 2.

The case 18 may further include a plurality of distinct receptacles 30 that are each positioned or otherwise configured to receive a portion of a respective electrical conductor or cable 32a, 32b, 32c, 32d (collectively “32”) emanating from a respective one of the plurality of USB ports 17a, 17b, 17c, 17d (collectively “17”) when charging the plurality of personal electronic devices 12. The receptacles 30 may be positioned on the same interior side of the case 18 in which the hub 16 is coupled such that the plurality of USB ports 17 are directed toward the plurality of distinct receptacles 30 when the hub 16 is secured to the case 18. Furthermore, each of the plurality of distinct receptacles 30 may be configured to receive the respective electrical conductor 32a, 32b, 32c, 32d emanating from the respective one of the plurality of USB ports 17 through a conductor inlet 34a, 34b, 34c, 34d (collectively “34”) and to store a portion of the electrical conductor 32a, 32b, 32c, 32d therein. Each of the plurality of distinct receptacles 30 may be further configured such that each respective electrical conductor 32a, 32b, 32c, 32d exits the receptacle 30 via a conductor outlet 36a, 36b, 36c, 36d (collectively “36”) distinct from the conductor inlet 34a, 34b, 34c, 34d, as shown best in FIG. 2.

In some embodiments, the distinct receptacles 30 may be open ended pouches which are each releasably securable along at least a portion of a common side thereof. In this manner, an edge of each pouch may be pulled back to fill the pouch with at least a portion of a respective electrical conductor or cable 32 and then replaced and re-secured to substantially enclose the portion of the respective electrical conductor or cable 32 and hide it from view with an end thereof extending through a respective outlet 36. Each pouch may be releasably securable to the case 18, for example, by way of hook and loop fastener devices, snaps, buttons or other coupling devices.

According to the example embodiment of FIGS. 1 through 5, the case 18 may further include at least one storage pocket 40 on an opposite side of the case 18. The pocket 40 may be used to store one or more of the personal electronic devices 12 chargeable via the portable charging station 10 or accessories for the same, such as, for example, a screen cleaning cloth. The pocket 40 may include mesh netting or other structures that conveniently reveal the contents therein. The pocket 40 may include closure mechanisms, such as, for example, magnets, snaps, zippers or hook and loop fasteners, for sealing or partially sealing the pocket 40 closed. The case 18 may include other slots, pockets or pouches for credit cards, business cards, passports or other items.

According to the example embodiment of FIGS. 1 through 5, the wall charger 14 includes an electrical conductor 44 for selective attachment to the hub 16 to enable power to be supplied to the hub 16 by way of the wall charger 14 during charging operations. The wall charger 14 may further include a peripheral recess 46 to receive the electrical conductor 44 wrapped about the wall charger 14 for storage within the case 18 in a particularly compact package, as shown, for example, in FIGS. 2 and 3.

As previously discussed, the charging hub 16 may include a built-in coupling cable 50, such as a retractable USB cable, that is in electrical communication with a USB data port 17d to enable syncing and charging of a personal electronic device 12 connected to the USB data port 17d from an auxiliary computing device, such as, for example, a desktop or laptop computer.

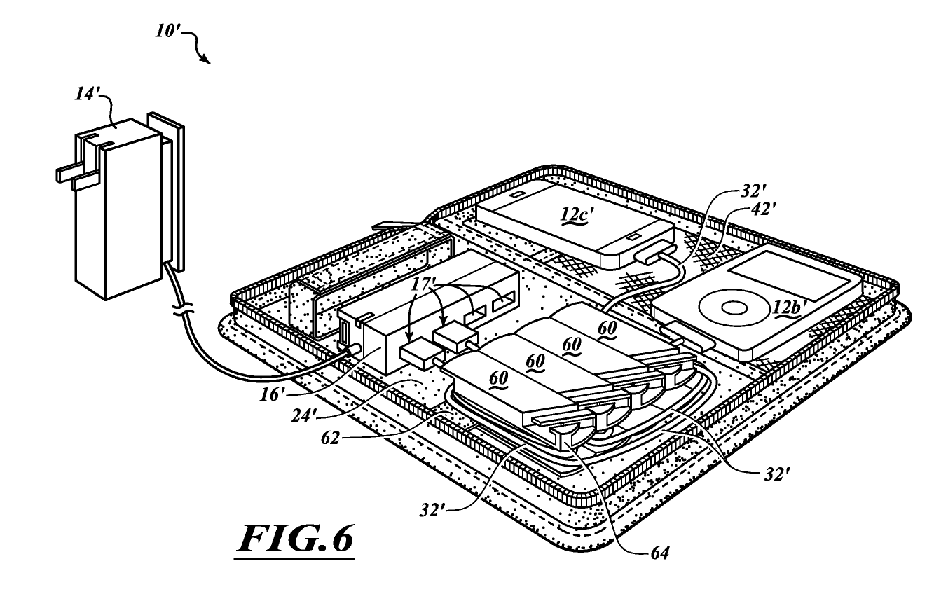

FIG. 6 shows a portable charging station 10′, according to another example embodiment, for selectively charging a plurality of personal electronic devices 12a′, 12b′ (collectively “12′”). In lieu of the distinct electrical conductor or cable receptacles 30 discussed above, the charging station 10′ may alternatively include a set of cable management devices 60 removably coupleable to the case 18′. For this purpose, the case 18′ may include mounting structures, such as, for example, receiving pockets 62, for selectively receiving or otherwise mating to each cable management device 60. Each of the cable management devices 60 may be configured to receive and store a portion of a respective conductor or cable 32′ emanating from a respective one of plurality of USB ports 17′ of the hub 16′ in a bundled or wrapping manner. Each of the cable management devices 60 may include a locking feature 64 at an end thereof to temporarily lock or restrain the respective conductor or cable 32′ from unwinding from the cable management device 60. A free end of each conductor or cable 32′ terminates in an electrical connector adapted to mate with a personal electronic device 12′ for charging purposes. As shown in FIG. 6, an opposing side 42′ of the case 18′ may provide a convenient surface with which to rest the personal electronic devices 12′ during charging.

According to some embodiments, the cable management devices 60 are readily separable from the case 18′ with the respective conductor or cable 32′ still wrapped thereabout. In this manner, a personal electronic device 12′ may be removed from the charging system 10′ altogether and plugged into another apparatus, such as, a laptop computer or the like with the conductor of cable 32′ thereof still neatly bundled about the cable management device 60. In other embodiments, the charging station 10′ may include a cable management device or devices 60 integrally or fixedly attached to the case 18′.

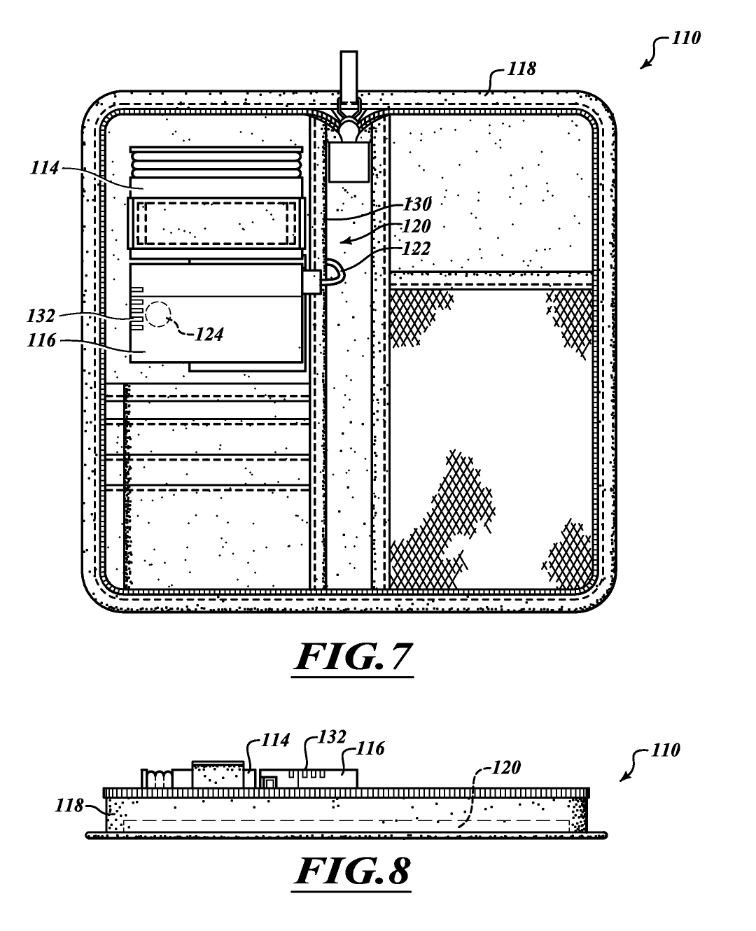

FIGS. 7 and 8 show a portable charging station 110, according to yet another example embodiment, for selectively charging a plurality of personal electronic devices (not shown). The portable charging station 110 may include many features or components that are the same or similar to those of the embodiments 10, 10′ described above, such as, for example, a wall charger 114, a charging hub 116 and a case 118. The portable charging station 110 may further include a battery 120, such as, for example, an integrated lithium polymer rechargeable battery pack, that is electrically coupled to the hub 116 to selectively supply power to the hub 116 for charging the plurality of personal electronic devices. The hub 116 may be electrically coupled to the battery 120, for example, by an electrical conductor 122 with an appropriate terminal.

In accordance with the embodiment shown in FIGS. 7 and 8, the hub 116 may include a switch 124 (e.g., push button, toggle, etc.) for switching between different device charging modes. In one charging mode, the charging station 110 is configured to supply power to the personal electronic devices from the hub 116 via the wall charger 114 when the wall charger 114 is coupled to an electrical wall outlet). In another charging mode, the charging station 110 is configured to supply power to the personal electronic devices from the hub 116 via the battery 120. In this manner, a user can conveniently switch between a battery charging mode for charging devices with the battery 120 and an outlet charging mode for charging devices via the wall charger 114. The wall charger 114 may also supply power to the battery 120 to recharge the battery 120 as desired.

The battery 120 may have a housing that is elongated and slender, and which is configured to be received within a corresponding pocket or compartment 130 of the case 118. The pocket or compartment 130 of the case 118 which is sized and shaped to receive the battery 120 may be located beneath or in near proximity to the locations where the wall charger 114 and hub 116 are stored during transport. In some embodiments, the battery 120 may have a rated capacity of at least 5200 mAh. In some embodiments, the hub 116 may also include indicator lights 132 that may indicate which type of charging mode the hub 116 is in and/or a charge status of the battery 120.

In view of the above, related methods of charging personal electronic devices 12, 12′ may be provided. According to one embodiment, for example, a method of charging personal electronic devices 12, 12′ may include: transporting the wall charger 14, 14′, 114 and the USB hub 16, 16′, 116 within the case 18, 18′, 118 to a remote location; removing the wall charger 14, 14′, 114 from the case 18, 18′, 118; electrically coupling the wall charger 14, 14′, 114 to a power source, such as mains power, and to the hub 16, 16′, 116 with the hub 16, 16′, 116 secured to the interior surface 24, 24′ of the case 18, 18′, 118; and coupling one or more of the personal electronic devices 12, 12′ to a respective USB port 17, 17′ of the hub 16, 16′, 116 to charge each personal electronic device 12, 12′.

In some embodiments, the method may further include switching between a first power mode in which the personal electronic devices 12, 12′ are charged via the wall charger 14, 14′, 114 through the intermediary of the hub 16, 16′, 116 and a second power mode in which the personal electronic devices 12, 12′ are charged via a battery 120 received in the case 18, 18′, 118 through the intermediary of the hub 16, 16′, 116.

In some embodiments, the method may further include storing a portion of at least one electrical conductor or cable 32 of the personal electronic devices 12 in a distinct receptacle 30 of the case 18 positioned adjacent to the charging hub 16. The method may further include routing at least one electrical conductor or cable 32 through the receptacle 30 via a conductor inlet 34 and a conductor outlet 36 of the receptacle 30 and bundling a substantial portion of the conductor or cable 32 within the receptacle 30. The method may further include resting at least one personal electronic device 12 on an interior surface 25 of the case 18 opposite a side 42 of the case 18 in which the hub 16 is secured while charging the personal electronic device 12. The method may further include syncing a personal electronic device 12 to an auxiliary computing device via a USB data port 17d of the hub 16 and a built-in coupling cable 50 of the hub 16. The method may further include simultaneously charging at least three personal electronic devices 12 via the hub 16 with the case 18 splayed open about a spine 66 thereof. In some embodiments, the method may further include bundling a portion of at least one electrical conductor or cable 32′ of the personal electronic devices 12′ about a cable management device 60 that is removably coupleable, or alternatively fixedly coupled, to the case 18′.

Moreover, aspects and features of the various embodiments of the portable charging stations 10, 10′, 110 and related methods described above can be combined to provide further embodiments. In addition, U.S. Provisional Patent Application No. 61/666,616, filed Jun. 29, 2012, is incorporated by reference for all purposes and aspects of the invention can be modified, if necessary, to employ features, systems, and concepts disclosed in the application to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A portable charging station to selectively charge a plurality of personal electronic devices, the portable charging station comprising:
a wall charger;
a hub separate from the wall charger and having a plurality of USB ports to selectively charge one or more of the plurality of personal electronic devices at least when the hub is electrically coupled to the wall charger during a charging operation; and
a case movable between a transport configuration in which the case encloses the wall charger and the hub and a charging configuration in which the case reveals the wall charger and the hub, the case including a hub securing device to secure the hub to the case at least when the case is in the transport configuration and a wall charger securing device to secure the wall charger to the case at least when the case is in the transport configuration.

2. The portable charging station of claim 1 wherein the case further includes a plurality of distinct receptacles each configured to receive a portion of a respective electrical conductor emanating from a respective one of the plurality of USB ports when charging the plurality of personal electronic devices.

3. The portable charging station of claim 2 wherein the case includes opposing sides, and wherein the hub securing device and the plurality of distinct receptacles are positioned on a same one of the opposing sides such that the plurality of USB ports are directed toward the plurality of distinct receptacles when the hub is secured to the case.

4. The portable charging station of claim 2 wherein each of the plurality of distinct receptacles is configured to receive the respective electrical conductor emanating from the respective one of the plurality of USB ports through a conductor inlet and to store a portion of the electrical conductor therein.

5. The portable charging station of claim 4 wherein each of the plurality of distinct receptacles is further configured such that each respective electrical conductor exits the receptacle via a conductor outlet distinct from the conductor inlet.

6. The portable charging station of claim 1 wherein the hub securing device is a pocket formed on an interior surface of the case, and wherein the hub includes an extension to slidably engage the pocket.

7. The portable charging station of claim 1 wherein the wall charger securing device includes an elastic loop coupled to an interior surface of the case to closely receive the wall charger when received therein.

8. The portable charging station of claim 1 wherein the wall charger securing device includes straps with hook and loop fastening devices to selectively secure the wall charger to the case.

9. The portable charging station of claim 1 wherein the case includes opposing sides, and wherein the wall charger securing device and the hub securing device are located on a same one of the opposing sides.

10. The portable charging station of claim 9 wherein the case further includes at least one storage pocket on a side of the case opposite the side on which the wall charger securing device and the hub securing device are located.

11. The portable charging station of claim 1 wherein the wall charger includes an electrical conductor to selectively attach to the hub and a peripheral recess to receive the electrical conductor when the wall charger is stored within the case.

12. The portable charging station of claim 1 wherein the hub includes a built-in retractable USB cable in electrical communication with a USB data port to enable syncing and charging of a personal electronic device connected to the USB data port from an auxiliary computing device when the built-in retractable USB cable is attached to the auxiliary computing device.

13. The portable charging station of claim 1, further comprising:
a set of cable management devices coupleable to the case opposite the plurality of USB ports, each cable management device configured to receive and store a portion of a respective conductor emanating from a respective one of plurality of USB ports in a bundled manner and readily separable from the case with the respective conductor to store the portion of the respective conductor apart from the case.

14. The portable charging station of claim 1, further comprising:
a rechargeable battery; and
wherein the hub includes a switch for switching between a battery charging mode for charging the plurality of personal electronic devices with the battery and an outlet charging mode for charging the plurality of personal electronic devices via the wall charger.

15. A portable charging station to selectively charge personal electronic devices, the portable charging station comprising:
a hub having a plurality of USB ports for selectively charging one or more personal electronic devices when coupled thereto;
a wall charger including an electrical conductor to selectively attach to the hub and connect the hub to a power source; and
a case movable between a transport configuration in which the case encloses the hub and the wall charger and a charging configuration in which the case reveals the wall charger and the hub, the case including a plurality of distinct receptacles each configured to receive a portion of a respective electrical conductor emanating from a respective one of the plurality of USB ports when charging the personal electronic devices.

16. The portable charging station of claim 15, further comprising:
a rechargeable battery; and
wherein the hub includes a switch for switching between a battery charging mode for charging the one or more personal electronic devices with the battery and an outlet charging mode for charging the one or more personal electronic devices via the wall charger.

17. A method of charging personal electronic devices, the method comprising:
transporting a wall charger and a USB hub within a case;
removing the wall charger from the case;
electrically coupling the wall charger to a power source and the hub with the hub secured to an interior surface of the case; and
coupling one or more of the personal electronic devices to a respective USB port of the hub to charge each personal electronic device.

18. The method of claim 17, further comprising:
storing a portion of at least one electrical conductor of the personal electronic devices in a distinct receptacle of the case which is positioned adjacent to the USB hub.

19. The method of claim 18, further comprising:
routing the at least one electrical conductor through the receptacle via a conductor inlet and a conductor outlet of the receptacle; and
bundling a substantial portion of the conductor within the receptacle.

20. The method of claim 17, further comprising:
resting at least one personal electronic device on an interior surface of the case opposite a side of the case in which the hub is secured while charging the personal electronic device.

21. The method of claim 17 wherein the hub is secured to the interior surface of the case by inserting an extension of the hub into a pocket that is integrally formed in the case.

22. The method of claim 17 wherein transporting the wall charger and the USB hub within the case includes transporting the wall charger and the USB hub with the wall charger and the USB hub secured on a same one of opposing sides of the case.

23. The method of claim 17, further comprising:
storing an electrical conductor which is configured to selectively attach to the USB hub within a peripheral recess of the wall charger when the wall charger is stored within the case.

24. The method of claim 17, further comprising:
syncing a personal electronic device to an auxiliary computing device via a USB data port of the USB hub and a built-in retractable USB cable of the USB hub.

25. The method of claim 17, further comprising:
simultaneously charging at least three personal electronic devices via the USB hub with the case splayed open about a spine thereof.

26. The method of claim 17, further comprising:
bundling a portion of at least one electrical conductor of the personal electronic devices about a cable management device that is removably coupleable to the case.

27. The method of claim 17, further comprising:
switching between a first power mode in which the one or more personal electronic devices are charged via the wall charger through the intermediary of the hub and a second power mode in which the one or more personal electronic devices are charged via a battery received in the case through the intermediary of the hub.
